(19) United States
(12) Patent Application Publication
(10) Pub. No.: US 2012/0048042 A1
(43) Pub. Date: Mar. 1, 2012

(54) MOTOR

(75) Inventor: Nobuaki Tanaka, Nagano (JP)

(73) Assignee: NIDEC SANKYO CORPORATION, Nagano (JP)

(21) Appl. No.: 13/186,653

(22) Filed: Jul. 20, 2011

(30) Foreign Application Priority Data
Aug. 31, 2010 (JP) 2010-193466

(51) Int. Cl. F16H 25/20

(52) U.S. Cl. 74/89.23

(57) ABSTRACT

A motor may include a rotation shaft having a male screw part on which a male screw is formed on at least an output side; a nut member which is formed with a female screw that is threadedly engaged with the male screw, the nut member being moved in an axial direction of the rotation shaft with rotation of the rotation shaft; a drive magnet; and a drive coil. The first angle which is an angle of a thread ridge of the male screw and a second angle which is an angle of a thread ridge of the female screw may be different from each other.

### CROSS REFERENCE TO RELATED APPLICATION

The present invention claims priority under 35 U.S.C. §119 to Japanese Application No. 2010-193466 filed Aug. 31, 2010, the entire content of which is incorporated herein by reference.

### FIELD OF THE INVENTION

At least an embodiment of the present invention may relate to a motor which is provided with a rotation shaft formed with a male screw part and a nut member engaged with the male screw part.

### BACKGROUND

Conventionally, a lens drive device for driving a lens of an optical pickup device has been known (see, for example, Japanese Patent Laid-Open No. 2010-72555). In the lens drive device described in the above-mentioned Patent Literature, a stepping motor is utilized as a drive source for driving the lens. In the lens drive device, a lead screw is formed on an output side of a rotation shaft of the stepping motor and a nut which is held by a nut holder is engaged with the lead screw. Further, the nut holder is attached to a lens holder which holds the lens. In the lens drive device, when the rotation shaft of the stepping motor is rotated, the nut holder is moved in an axial direction of the rotation shaft together with the nut and, with movement of the nut holder, the lens is moved in the optical axis direction together with the lens holder.

In some of the lens drive devices, when a power source is turned to an “ON” state from an “OFF” state, home positioning of the lens is performed in which the lens is moved to a predetermined home position. When home positioning of the lens is to be performed, for example, regardless of the position of the lens holder, first, the stepping motor is rotated to move the nut together with the lens holder and the like to a final position in a moving range and, after the nut is collided with a predetermined stopper and is stopped, the lens holder is moved to a predetermined reference position by rotating the stepping motor in a reverse direction by a specified quantity. When the above-mentioned home positioning is to be performed, in order to make the nut collide with the stopper surely, a rotational force is applied to the nut by a predetermined time period by the stepping motor even when the nut is abutted with the stopper. Therefore, it may be occurred that the nut is bitten to the lead screw by the rotational force and thus, the nut does not move even when the stepping motor is rotated in the reverse direction.

In order to eliminate the problem, in the stepping motor described in the above-mentioned Patent Literature, a small-diameter screw thread part whose outer diameter is small is formed in a predetermined range of an end part of the lead screw and the nut is prevented from being bitten to the end part of the lead screw through the operation of the small-diameter screw thread part.

However, in the stepping motor described in the above-mentioned Patent Literature, in a case that a relative positional accuracy between the small-diameter screw thread part and the stopper is low, the nut may bite to the lead screw without reaching to the small-diameter screw thread part although the nut is collided with the stopper. Further, when the relative positional accuracy between the small-diameter screw thread part and the stopper is low, the nut may have reached to the small-diameter screw thread part before the nut is collided with the stopper and thus the nut is unable to be moved to a position where the nut is collided with the stopper. In order to eliminate the above-mentioned problems, the lead screw is required to be worked with a high degree of accuracy but a working cost for the lead screw becomes high.

### SUMMARY

In view of the problems described above, at least an embodiment of the present invention may advantageously provide a motor which is provided with a rotation shaft formed with a male screw part and a nut member engaged with the male screw part and which is capable of restraining biting of the nut member to the male screw part with a relatively simple structure.

According to at least an embodiment of the present invention, there may be provided a motor including a rotation shaft having a male screw part on which a male screw is formed on at least an output side, a nut member which is formed with a female screw that is threadedly engaged with the male screw and which is moved in an axial direction of the rotation shaft with rotation of the rotation shaft, a drive magnet, and a drive coil. In this motor, a first angle which is an angle of a thread ridge of the male screw and a second angle which is an angle of a thread ridge of the female screw are different from each other.

In the motor in accordance with an embodiment of the present invention, a first angle which is an angle of a thread ridge of the male screw and a second angle which is an angle of a thread ridge of the female screw are different from each other. Therefore, a contact area of a flank face of the male screw with a flank face of the female screw is reduced and thus, even when the rotation shaft is further rotated in a state that the nut member or a member attached to the nut member is abutted with a stopper, the flank face of the male screw and the flank face of the female screw are hard to be tightly abutted with each other. Therefore, in accordance with the embodiment of the present invention, biting of the nut member to the male screw part is restrained with a relatively simple structure, that is, a structure that an angle of a thread ridge of the male screw and an angle of a thread ridge of the female screw are different from each other.

In accordance with an embodiment of the present invention, a diameter of a contact portion of a flank face of the male screw with a flank face of the female screw when the nut member is moved in the axial direction is larger than an effective diameter of the female screw. In other words, in accordance with an embodiment of the present invention, the second angle is set to be larger than the first angle. For example, the first angle is 60° and the second angle is larger than 60°. Specifically, the second angle may be set to be not less than 62° but not more than 70° and it is preferable that the second angle is set to be not less 64° but not more than 68°. In accordance with an embodiment of the present invention, the first angle is not required to be set at 60°. When a relationship of difference of the first angle, i.e., an angle of a thread ridge of the male screw, from the second angle, i.e., an angle of a thread ridge of the female screw, is expressed by percentage, the second angle may be set to be different from the first angle in a range of not less than 3.3% but not more than 16.6%. According to this structure, a contact area of the flank face of the male screw with the flank face of the female screw is reduced and biting of the nut member to the male screw part is restrained while a gap space (clearance) between the male screw and the female screw is set to be relatively small. Further, when a diameter of a contact portion of the flank face of the male screw with the flank face of the female screw is set to be larger than an effective diameter of the female screw, an engaging height (engaging amount) of the male screw with the female screw is secured and the nut member can be moved appropriately by the male screw part.

In accordance with an embodiment of the present invention, the motor is a stepping motor, and the embodiment of the present invention is preferably applicable to a case that the nut member is collided with a stopper through rotation of the rotation shaft for being positioned at a predetermined reference position. In this case, for example, even when a rotational force is applied to the rotation shaft for a predetermined time period after movement of the nut member has been stopped in the axial direction of the rotation shaft by the stopper, since the first angle which is an angle of a thread ridge of the male screw and the second angle which is an angle of a thread ridge of the female screw are different from each other, biting of the nut member to the male screw part is restrained.

In accordance with an embodiment of the present invention, the motor is provided with a stator having the drive coil, and a frame for supporting an output end side of the rotation shaft, and the stator or the frame functions as a stopper for stopping the nut member when the nut member is to be moved to a predetermined reference position. According to this structure, a stopper for stopping the nut member is not required to be separately provided when the nut member is to be moved to a predetermined reference position. Therefore, the structure of the motor can be simplified.

Other features and advantages will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a partially sectional view showing a motor in accordance with an embodiment of the present invention.

FIG. 2 is an enlarged cross-sectional view showing an engagement part of a lead screw with a nut member shown in FIG. 1.

FIG. 3 is an enlarged view showing an “E” part in FIG. 2.

FIG. 4 is an enlarged view showing a state when the nut member shown in FIG. 3 is being moved to an opposite-to-output side.

FIG. 5 is a table showing dimension set values of female screws which are used in comparison tests regarding a return moving amount of a nut member.

FIG. 6 is a graph showing examination results of a return moving amount of a nut member when a female screw in a comparison example is used.

FIG. 7 is a graph showing examination results of a return moving amount of a nut member when a female screw in a first example is used.

FIG. 8 is a graph showing examination results of a return moving amount of a nut member when a female screw in a second example is used.

FIG. 9 is a graph showing examination results of a return moving amount of a nut member when a female screw in a third example is used.

FIG. 10 is a graph showing examination results of a return moving amount of a nut member when a female screw in a fourth example is used.

FIG. 11 is a table showing measurement results of clearances of the nut members having a female screw to a lead screw which are used in the comparison test regarding a return moving amount of the nut member.

### DETAILED DESCRIPTION OF THE PREFERRED EMBODIMENTS

An embodiment of the present invention will be described below with reference to the accompanying drawings.

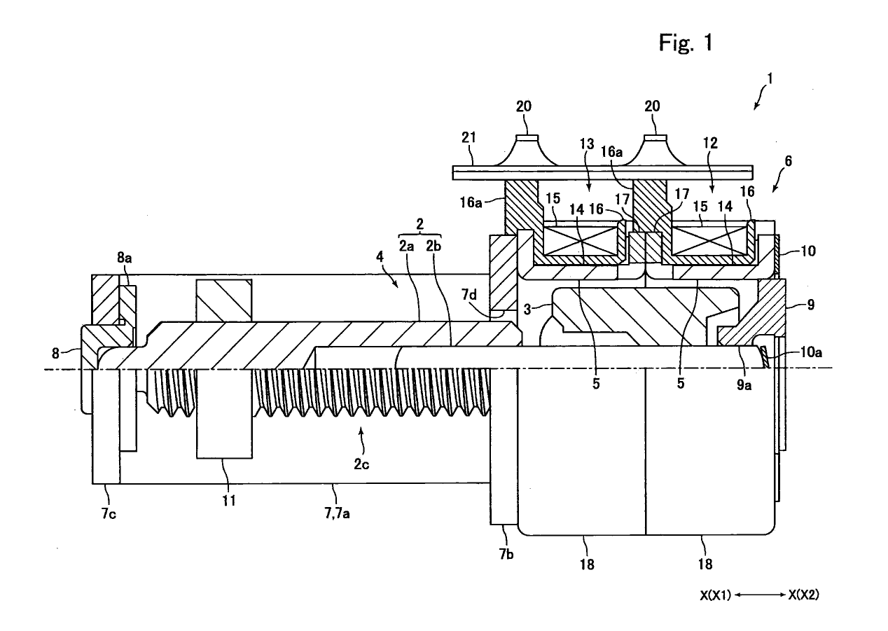

FIG. 1 is a partially sectional view showing a motor 1 in accordance with an embodiment of the present invention.

The motor 1 in this embodiment is a so-called PM type stepping motor. The motor 1 is, for example, a lens drive motor which is used for moving a collimator lens of an optical pickup device for Blu-ray disc in an optical axis direction. The motor 1 is mounted and used in the optical pickup device. The motor 1 is, as shown in FIG. 1, provided with a rotor 4 having a rotation shaft 2 and a drive magnet 3, a stator 6 having pole teeth 5 which is oppositely disposed to the drive magnet 3 on an outer side in a radial direction of the drive magnet 3, and a frame 7 which is attached to the stator 6 on an output side of the rotation shaft 2. Further, the motor 1 is provided with a bearing 8 for supporting an end part on an output side of the rotation shaft 2, a bearing 9 for supporting an end part on an opposite-to-output side of the rotation shaft 2, and a flat spring 10 for urging the rotation shaft 2 to the output side.

In the following descriptions, an “X1” direction side in FIG. 1 which is an output side of the rotation shaft 2 is referred to as an “output side” and an “X2” direction side in FIG. 1 which is an opposite-to-output side of the rotation shaft 2 is referred to as an “opposite-to-output side”. Further, an “X” direction in FIG. 1 which is an axial direction of the rotation shaft 2 is referred to as an “axial direction” and a direction perpendicular to the axial direction is referred to as a “radial direction”.

The rotation shaft 2 is formed of metal such as stainless steel, aluminum or brass. The rotation shaft 2 in this embodiment is structured of a lead screw 2a as a male screw part which is disposed on the output side and a long and thin shaft part 2b which is formed in a cylindrical shape and is disposed on the opposite-to-output side. A male screw 2c is formed on an outer peripheral face of the lead screw 2a.

An outer diameter of the lead screw 2a is larger than an outer diameter of the shaft part 2b. The lead screw 2a is fixed to the output side of the shaft part 2b and is protruded from the stator 6. A nut member 11 is engaged with the lead screw 2a. The nut member 11 is attached to a lens holder which holds a collimator lens of an optical pickup device through a predetermined member. In this embodiment, when the rotation shaft 2 is rotated, the nut member 11 is moved in the axial direction and, with movement of the nut member 11, the collimator lens is moved in its optical axis direction. Detailed structure of the lead screw 2a and the nut member 11 will be described below.

The drive magnet 3 is a permanent magnet which is formed in a substantially cylindrical tube shape. The drive magnet 3 is fixed to an outer peripheral face of the shaft part 2b of the rotation shaft 2 which is disposed on an inner side of the stator 6 (in other words, an outer peripheral face on the opposite-to-output side of the rotation shaft 2). An “N”-pole and an “S”-pole are alternately magnetized on the outer peripheral face of the drive magnet 3 along its circumferential direction.

The stator 6 is provided with a first stator assembly 12 and a second stator assembly 13 which are disposed so as to superpose on each other in the axial direction. The first stator assembly 12 is disposed on the opposite-to-output side and the second stator assembly 13 is disposed on the output side. The first stator assembly 12 is provided with an outer stator core 14, a bobbin 16 around which a drive coil 15 is wound, an inner stator core 17 which sandwiches the bobbin 16 with the outer stator core 14, and a case 18. The second stator assembly 13 is, similarly to the first stator assembly 12, provided with an outer stator core 14, a bobbin 16 around which a drive coil 15 is wound, an inner stator core 17, and a case 18.

The bobbin 16 is formed in a substantially cylindrical tube shape with a flange and the drive coil 15 is wound around its outer peripheral face in a substantially cylindrical tube shape. A plurality of the pole teeth 5 which is formed in each of the outer stator core 14 and the inner stator core 17 is disposed on the inner peripheral side of the bobbin 16 so as to be adjacent to each other in the circumferential direction. The case 18 covers outer peripheral sides of the outer stator core 14, the drive coil 15, the bobbin 16 and the inner stator core 17. Further, the bobbin 16 is formed with a terminal block 16a which is protruded to an outer side in the radial direction. The terminal block 16a is fixed with terminal pins 20 and a circuit board 21 for supplying an electric current to the drive coils 15. An end part of the drive coil 15 is wound around the terminal pin 20. The case 18 may be integrally formed with the outer stator core 14 or may be separately formed from the outer stator core 14. In this embodiment, the case 18 is integrally formed with the outer stator core 14. Specifically, the case 18 is formed so as to be connected with an outer circumferential edge of the outer stator core 14.

The frame 7 is a metal frame which is formed of a metal thin plate. The frame 7 is formed in a rectangular groove shape (“U”-like shape in cross section) which is provided with a bottom face part 7a and two side face parts 7b and 7c that are formed so as to be stood up from the bottom face part 7a and are disposed so as to face each other.

The side face part 7b is disposed on the opposite-to-output side and is fixed to the stator 6. The side face part 7b is formed with an insertion hole 7d through which the opposite-to-output side of the lead screw 2a is inserted so as to penetrate through the side face part 7b. An inner diameter of the insertion hole 7d is formed larger than an outer diameter of the lead screw 2a and a gap space is formed between the inner peripheral face of the insertion hole 7d and the lead screw 2a. The side face part 7c is disposed on the output side and is fixed with a bearing 8. In other words, the side face part 7c of the frame 7 functions so that the output end side of the rotation shaft 2 is supported through the bearing 8.

The bearing 8 is formed of, for example, resin whose sliding property is superior. Further, the bearing 8 is, for example, formed in a bottomed cylindrical tube shape with a flange. An end part on the output side of the rotation shaft 2 is disposed on an inner peripheral side of the bearing 8. In this embodiment, the end part on the output side of the rotation shaft 2 is supported by the bearing 8 in the axial direction and the radial direction.

The bearing 9 is formed of, for example, resin whose sliding property is superior. The bearing 9 is fixed to the opposite-to-output side of the stator 6. Further, the bearing 9 is formed in a substantially cylindrical tube shape with a flange and a portion formed in a substantially cylindrical tube shape is a shaft holding part 9a which holds an outer peripheral face of an opposite-to-output side end part of the rotation shaft 2. An end part on the opposite-to-output side of the rotation shaft 2 is movable in the axial direction while sliding on the inner peripheral face of the shaft holding part 9a. In this embodiment, the end part on the opposite-to-output side of the rotation shaft 2 is supported by the bearing 9 in the radial direction.

A flat spring 10 is attached to an opposite-to-output side of the stator 6. A center part of the flat spring 10 is formed with a spring part 10a which is abutted with an opposite-to-output side end of the rotation shaft 2 to urge the rotation shaft 2 to the output side.

In a pickup device on which the motor 1 is mounted, when a power source is turned to an “ON” state from an “OFF” state, home positioning of a collimator lens in which the collimator lens is moved to a predetermined home position is performed. In this embodiment, when the home positioning of a collimator lens is to be performed, the rotation shaft 2 is rotated, for example, until the nut member 11 is moved to a position where the lens holder holding the collimator lens is abutted with a predetermined stopper and then stopped and, in this manner, the collimator lens is moved to the home position. In this case, in order that the lens holder is surely abutted with the stopper, a rotational force is applied to the rotation shaft 2 by a predetermined time period even when the lens holder is abutted with the stopper.

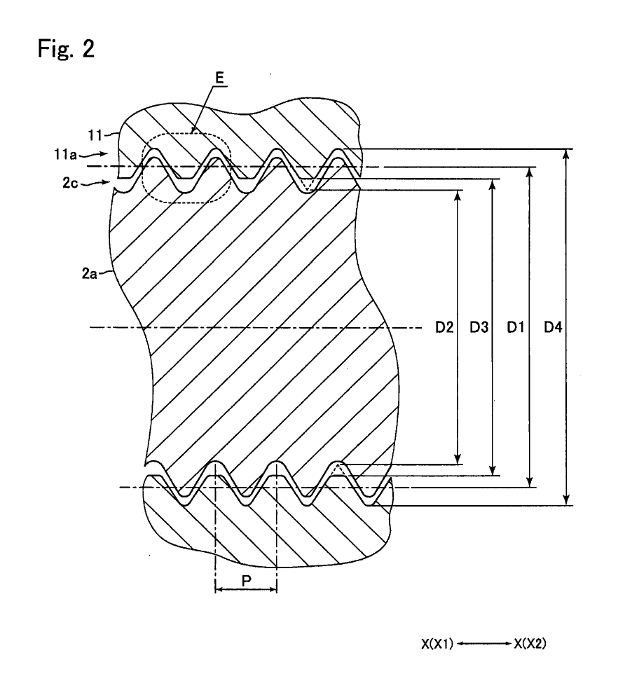

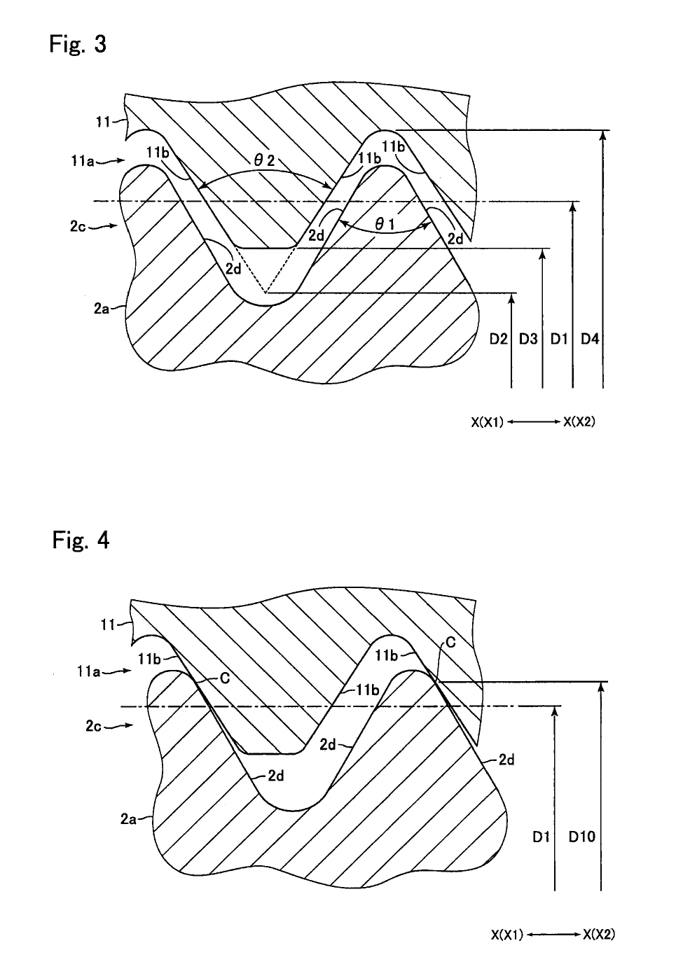

FIG. 2 is an enlarged cross-sectional view showing an engagement part of the lead screw 2a with the nut member 11 shown in FIG. 1. FIG. 3 is an enlarged view showing an “E” part in FIG. 2. FIG. 4 is an enlarged view showing a state when the nut member 11 shown in FIG. 3 is being moved to an opposite-to-output side.

As described above, the male screw 2c is formed on the outer peripheral face of the lead screw 2a. Further, the lead screw 2a is formed by rolling work, cutting work or grinding work. The male screw 2c is a triangular screw which is formed so that a cross-sectional shape of its thread ridge is formed in a substantially equilateral triangular shape. In this embodiment, an angle θ1 of the thread ridge of the male screw 2c (hereinafter, referred to as a “first angle θ1”) is set to be 60°.

The nut member 11 is, for example, formed of resin. An inner peripheral face of the nut member 11 is a female screw part which is formed with the female screw 11a that is threadedly engaged with the male screw 2c. The female screw 11a is formed by molding or by using a rolling tap or a cutting tap. Further, the female screw 11a is a triangular screw which is formed so that a cross-sectional shape of its thread ridge is formed in a substantially equilateral triangular shape. An angle θ2 of the thread ridge of the female screw 11a (hereinafter, referred to as a “second angle θ2”) is different from the first angle θ1. Specifically, the second angle θ2 is set to be larger than the first angle θ1. The second angle θ2 in this embodiment is 66°. In accordance with an embodiment of the present invention, the second angle θ2 may be set to be smaller than the first angle θ1. Further, the nut member 11 may be formed of metal such as stainless steel, aluminum or brass.

In this embodiment, an effective diameter “D1” of the female screw 11a is set to be larger than an effective diameter of the male screw 2c. Therefore, a gap space (clearance) is formed between the female screw 11a and the male screw 2c. Further, as described above, the second angle θ2 is different from the first angle θ1. Therefore, when the nut member 11 is moved in the axial direction with rotation of the lead screw 2a, as shown in FIG. 4, a flank face 2d of the male screw 2c and a flank face 11b of the female screw 11a are brought in line contact with each other. In addition, since the second angle θ2 is set to be larger than the first angle θ1, as shown in FIG. 4, a diameter “D10” at a contact portion “C” of the flank face 2d with the flank face 11b when the nut member 11 is moved in the axial direction with the rotation of the lead screw 2a is larger than the effective diameter “D1” of the female screw 11a. In accordance with an embodiment of the present invention, when the second angle θ2 is set to be smaller than the first angle θ1, the diameter “D10” at the contact portion “C” of the flank face 2d with the flank face 11b is smaller than the effective diameter “D1” of the female screw 11a.

As described above, in this embodiment, the first angle θ1 which is an angle of a thread ridge of the male screw 2c is different from the second angle θ2 which is an angle of a thread ridge of the female screw 11a. Therefore, a contact area of the flank face 2d of the male screw 2c with the flank face 11b of the female screw 11a becomes small and thus, even when the rotation shaft 2 is further rotated in a state that the lens holder holding the collimator lens is abutted with a stopper, the flank face 2d and the flank face 11b are hard to be tightly abutted with each other. Therefore, in this embodiment, biting of the nut member 11 to the lead screw 2a can be restrained by utilizing a relatively simple structure in which an angle of a thread ridge of the male screw 2c is set to be different from an angle of a thread ridge of the female screw 11a.

This effect will be specifically described below on the basis of results of comparison tests. In the following descriptions, a rotating direction of the rotation shaft 2 when the nut member 11 is moved toward the opposite-to-output side is set to be a CW (clockwise) direction and a rotating direction of the rotation shaft 2 when the nut member 11 is moved toward the output side is set to be a CCW (counterclockwise) direction.

In the comparison test, first, the nut member 11 is disposed at a position where a distance between the end face of the lens holder holding the collimator lens and the end face of the stopper for restricting movement of the lens holder is 3.72 mm. After that, the rotation shaft 2 is rotated in the CCW direction so that the end face of the lens holder is contacted with the end face of the stopper. In this case, a pulse signal having the number of steps with which a moving amount in calculation of the nut member 11 to the output side is set to be 3.84 mm is inputted to the drive coil 15 and the end face of the lens holder is surely collided with the end face of the stopper. After that, while changing the voltage applied to the drive coil 15 and, in addition, a pulse signal having the number of steps with which a moving amount in calculation of the nut member 11 to the opposite-to-output side is set to be 3.72 mm is inputted to the drive coil 15 and an actual moving amount of the nut member 11 (return moving amount) when the rotation shaft 2 has been rotated in the CW direction is measured.

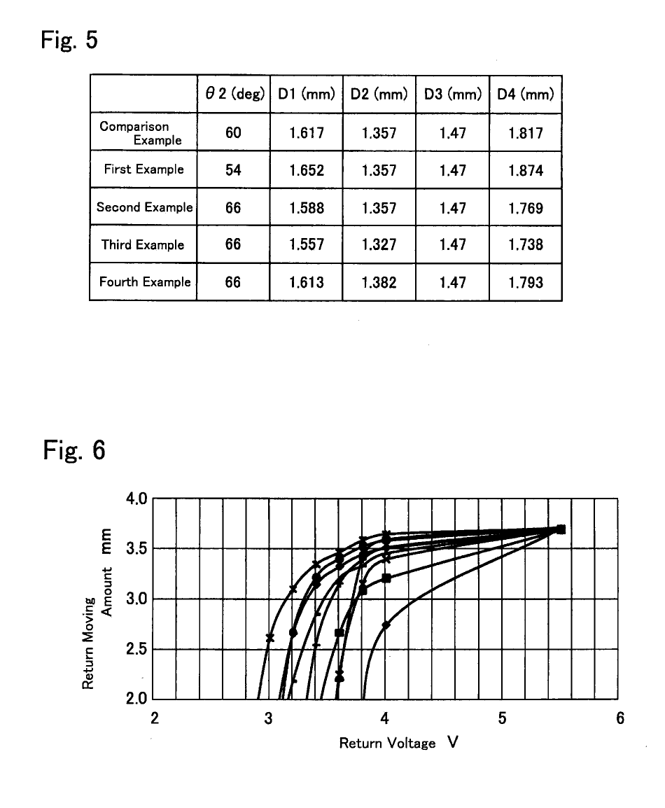

Further, in the comparison tests, return moving amounts of the nut member 11 are measured by using five types of the female screws 11 a in which the angle of the thread ridge of the male screw 2c (in other words, the first angle θ1) and the effective diameter and the like of the male screw 2c are set to be the same and the angles of the thread ridges of the female screws 11a (in other words, the second angle θ2) and the effective diameters “D1” of the female screws 11a are different from each other. Further, in the comparison tests, return moving amounts of a plurality of the nut members 11 are measured which are formed as each of the five types of the female screws 11a. The first angle θ1 of the male screw 2c used in the comparison test is 60°, the effective diameter of the male screw 2c is 1.505 mm, the outer diameter of the male screw 2c is 1.7 mm, and the pitch of the male screw 2c is 0.3 mm. Further, in the five types of the female screws 11a (female screw 11a in a comparison example and female screws 11a in a first example through a fourth example) which are used in the comparison tests, the second angle θ2, the effective diameter “D1”, the diameter “D2” of a virtual vertex of a thread ridge of the female screw 11a (point where two lines formed by extending two flank faces 11b structuring one thread ridge are intersected with each other), the inner diameter “D3” of the female screw 11a, and the diameter “D4” of a valley of the female screw 11a (see FIGS. 2 and 3) are set as shown in FIG. 5. Further, a pitch “P” of the female screw 11a is 0.3 mm.

In the female screw 11a in the comparison example and the female screw 11a in the first example and the female screw 11a in the second example, the diameters “D2” of the virtual vertexes of the thread ridges of the female screws 11a and the inner diameters “D3” of the female screws 11a are the same as each other but the second angles θ2 are different from each other. Further, in the female screw 11a in the second example and the female screw 11a in the third example and the female screw 11a in the fourth example, the inner diameters “D3” and the second angles θ2 of the female screws 11a are the same as each other but the diameters “D2” of the virtual vertexes of the thread ridges of the female screws 11a and the diameters “D4” of valleys of the female screws 11a are different from each other and, as a result, their effective diameters “D1 ” are different from each other.

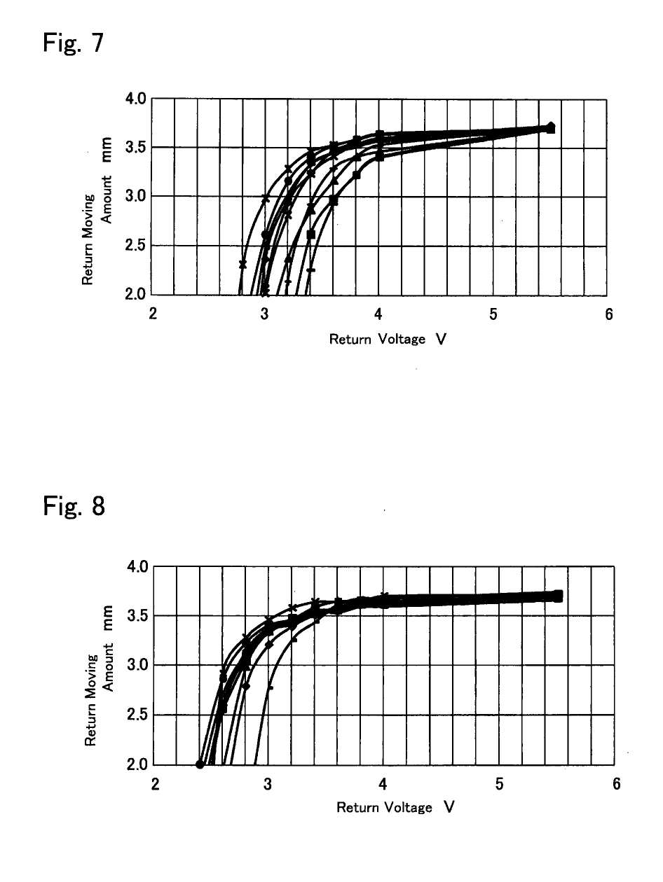

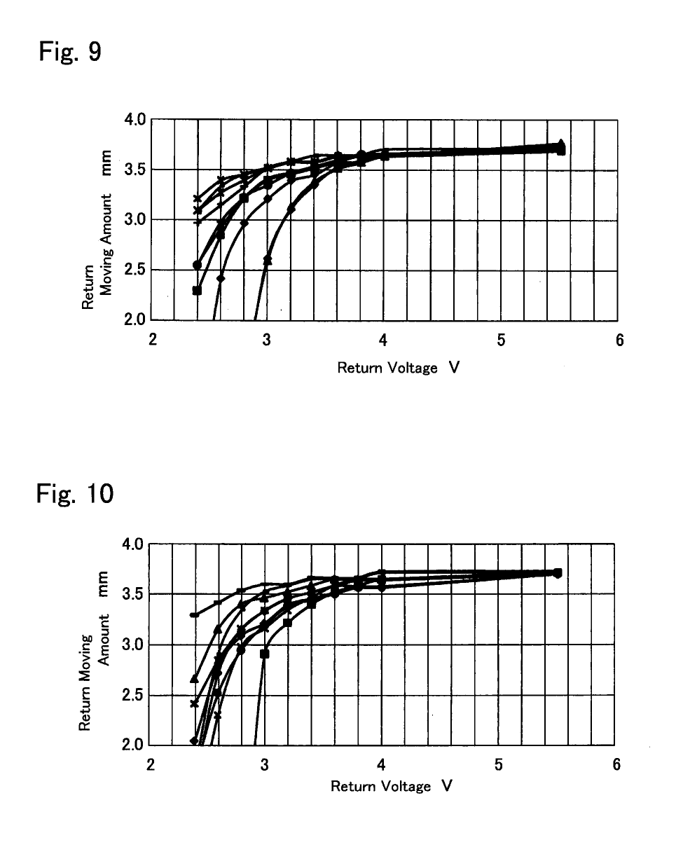

Results of the comparison tests are shown in FIGS. 6 through 10. Examination results shown in FIG. 6 are those when the female screw 11a in the comparison example is used. Examination results shown in FIG. 7 are those when the female screw 11a in the first example is used, examination results shown in FIG. 8 are those when the female screw 11a in the second example is used, examination results shown in FIG. 9 are those when the female screw 11a in the third example is used, and examination results shown in FIG. 10 are those when the female screw 11a in the fourth example is used,

As shown in FIGS. 6 through 10, in comparison with the case that the female screw 11a in the comparison example in which the first angle θ1 and the second angle θ2 are the same as each other is used, when the female screws 11a in the first through the fourth examples in which the first angle θ1 and the second angle θ2 are different from each other are used, return moving amounts of the nut member 11 become large even when a voltage applied to the drive coil 15 (return voltage) is low. In other words, in comparison with the case that the female screw 11a in the comparison example is used, when the female screws 11a in the first through the fourth examples are used, return voltages required to move the nut member 11 by a predetermined amount are low and biting of the nut member 11 to the lead screw 2a is restrained when the end face of the lens holder is collided with the end face of the stopper. As described above, when the first angle θ1 and the second angle θ2 are different from each other, biting of the nut member 11 to the lead screw 2a can be restrained.

Further, as shown in FIGS. 7 through 10, in comparison with the case that the female screw 11a in the first example is used in which the second angle θ2 is smaller than the first angle θ1, when the female screws 11a in the second example through the fourth example are used in which the second angle θ2 is larger than the first angle θ1, the return voltages required to move the nut member 11 by a predetermined amount are further lowered and biting of the nut member 11 to the lead screw 2a is further restrained when the end face of the lens holder is collided with the end face of the stopper. As described above, when the second angle θ2 is larger than the first angle θ1, biting of the nut member 11 to the lead screw 2a is effectively restrained.

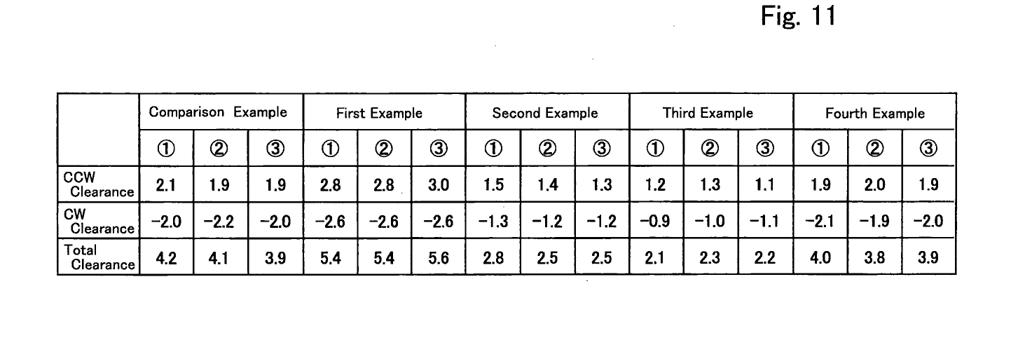

Further, when the female screw 11a in the comparison example and the female screws 11a in the first through the fourth examples are used, a clearance of the nut member 11 to the lead screw 2a (gap space between the male screw 2c and the female screw 11a) is shown in FIG. 11. In other words, as the second angle θ2 becomes larger and, as the effective diameter “D1” of the female screw 11a becomes smaller, the clearance of the nut member 11 to the lead screw 2a becomes smaller. FIG. 11 shows results obtained by measuring a clearance of the nut member 11 to the lead screw 2a for three samples of each of the female screw 11a in the comparison example and the female screws 11a in the first through the fourth examples. Further, the CCW clearance is an inclination angle of the nut member 11 with respect to a direction perpendicular to the axial direction when a force is applied to the nut member 11 in a plane parallel to the bottom face part 7a of the frame 7 and in a plane passing through the axial center of the lead screw 2a so that the nut member 11 is inclined to the output side in a state that the lead screw 2a is stopped. The CW clearance is an inclination angle of the nut member 11 with respect to a direction perpendicular to the axial direction when a force is applied to the nut member 11 in a plane parallel to the bottom face part 7a of the frame 7 and in a plane passing through the axial center of the lead screw 2a so that the nut member 11 is inclined to the opposite-to-output side in a state that the lead screw 2a is stopped. Further, the total clearance is the sum of the CCW clearance and the CW clearance.

Although the present invention has been shown and described with reference to a specific embodiment, various changes and modifications will be apparent to those skilled in the art from the teachings herein.

The second angle θ2 of the female screw 11a in the second through the fourth examples which is used in the above-mentioned embodiment and the above-mentioned comparison tests is 66°. However, the second angle θ2 may be an arbitrary angle which is more than 60° . For example, the second angle θ2 may be 63°. Even in this case, biting of the nut member 11 to the lead screw 2a is restrained. In accordance with an embodiment of the present invention, when the first angle θ1 is 60°, in order to secure an engaging height (engaging amount) of the male screw 2c with the female screw 11a, it is preferable that the second angle θ2 is not more than 70°. In other words, in order to reduce a contact area of the flank face 2d of the male screw 2c with the flank face 11b of the female screw 11a and secure the engaging height (engaging amount) of the male screw 2c with the female screw 11a, it is preferable that the second angle θ2 is set to be not less than 64° but not more than 68°. However, when the second angle θ2 is set to be not less than 62° but not more than 70°, a similar effect can be obtained. When this relationship of difference of the first angle θ1 from the second angle θ2 is expressed by percentage, it is preferable that the second angle θ2 is different from the first angle θ1 in a range of not less than 6.6% but not more than 13.3%. However, the second angle θ2 may be set so as to be different from the first angle θ1 in a range of not less than 3.3% but not more than 16.6%.

Further, the second angle θ2 of the female screw 11a in the first example which is used in the comparison tests is 54°. However, when the second angle θ2 is smaller than the first angle θ1, the second angle θ2 may be set at an arbitrary angle less than 60°.

In the female screws 11 a in the first through the fourth examples which are used in the above-mentioned embodiment and the above-mentioned comparison tests, the first angle θ1 is 60° and the second angle θ2 is different from the first angle θ1. However, the present invention is not limited to this embodiment. For example, it may be structured that the second angle θ2 is 60° and the first angle θ1 is different from the second angle θ2. Alternatively, it may be structured that the first angle θ1 is an angle other than 60° and the second angle θ2 is different from the first angle θ1. In these cases, the relationship of difference of the first angle θ1 from the second angle θ2 may be set so that the first angle θ1 is different from the second angle θ2 in a similar range to the above-mentioned case that the second angle θ2 is larger than the first angle θ1.

In the embodiment described above, when home positioning of a collimator lens is to be performed, the collimator lens is moved to the home position by making the nut member 11 move to and stop at a position where the lens holder holding the collimator lens is abutted with a predetermined stopper. However, the present invention is not limited to this embodiment. For example, when home positioning of a collimator lens is to be performed, it may be structured that the nut member 11 is moved to a reference position by making the nut member 11 move to and stop at a position abutting with an end face on the opposite-to-output side of the flange part 8a of the bearing 8 which is fixed to the side face part 7c and, in this manner, the collimator lens is moved to the home position. Alternatively, it may be structured that the nut member 11 is moved to a reference position by making the nut member 11 move to and stop at a position abutting with an end face of the output side of the side face part 7b and, in this manner, the collimator lens is moved to the home position. In these cases, the frame 7 functions as a stopper for stopping the nut member 11 when the nut member 11 is moved to the reference position. Therefore, a stopper is not required to be separately provided for stopping the nut member 11 when the nut member 11 is moved to the reference position. Accordingly, the structure of the motor 1 can be simplified.

In the embodiment described above, the rotor 4 is provided with one piece of drive magnet 3 but the number of the drive magnet 3 provided in the rotor 4 may be two pieces or more. Further, in the embodiment described above, the stator 6 is structured of the first stator assembly 12 and the second stator assembly 13. However, the stator 6 may be structured of three or more stator assemblies.

In the embodiment described above, the motor 1 is a lens drive motor which is used for moving a collimator lens in an optical pickup device for Blu-ray disc in the optical axis direction but the motor 1 may be a motor which is used for other purposes. For example, the motor 1 may be a lens drive motor for moving a lens for a digital camera or the like in the optical axis direction. Further, in the embodiment described above, the motor 1 is a stepping motor. However, the structure of the present invention may be applicable to a motor other than a stepping motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotation shaft having a male screw part on which a male screw is formed on at least an output side;
a nut member which is formed with a female screw that is threadedly engaged with the male screw, the nut member being moved in an axial direction of the rotation shaft with rotation of the rotation shaft;
a drive magnet; and
a drive coil;
wherein a first angle which is an angle of a thread ridge of the male screw and a second angle which is an angle of a thread ridge of the female screw are different from each other.

2. The motor according to claim 1, wherein a diameter of a contact portion of a flank face of the male screw with a flank face of the female screw when the nut member is moved in the axial direction is larger than an effective diameter of the female screw.

3. The motor according to claim 2, wherein the first angle is 60° and the second angle is set to be larger than 60°.

4. The motor according to claim 3, wherein the second angle is not less than 62° but not more than 70°.

5. The motor according to claim 4, wherein the second angle is not less than 64° but not more than 68°.

6. The motor according to claim 5, wherein the second angle is 66°.

7. The motor according to claim 4, wherein
the motor is a stepping motor, and
the nut member is collided with a stopper through rotation of the rotation shaft to be positioned to a predetermined reference position.

8. The motor according to claim 7, wherein a rotational force is applied to the rotation shaft for a predetermined time period even when movement of the nut member is stopped in the axial direction of the rotation shaft by the stopper.

9. The motor according to claim 1, further comprising
a stator having the drive coil, and
a frame for supporting an output end side of the rotation shaft,
wherein the stator or the frame functions as a stopper for stopping the nut member when the nut member is to be moved to a predetermined reference position.

10. The motor according to claim 1, wherein the second angle is set to be larger than the first angle.

11. The motor according to claim 10, wherein the first angle is 60° and the second angle is set to be larger than 60°.

12. The motor according to claim 11, wherein the second angle is not less than 62° but not more than 70°.

13. The motor according to claim 12, wherein the second angle is not less than 64° but not more than 68°.

14. The motor according to claim 13, wherein the second angle is 66°.

15. The motor according to claim 10, further comprising
a stator having the drive coil, and
a frame for supporting an output end side of the rotation shaft,
wherein the stator or the frame functions as a stopper for stopping the nut member when the nut member is to be moved to a predetermined reference position.

16. The motor according to claim 10, wherein
the motor is a stepping motor, and
the nut member is collided with a stopper through rotation of the rotation shaft to be positioned to a predetermined reference position, and
the second angle is different from the first angle in a range of not less than 3.3% but not more than 16.6% so that biting of the nut member to the rotation shaft when the nut member is collided with an end face of the stopper is restrained.

17. The motor according to claim 16, wherein a rotational force is applied to the rotation shaft for a predetermined time period even when movement of the nut member is stopped in the axial direction of the rotation shaft by the stopper.
